(19) United States
(12) Patent Application Publication
(10) Pub. No.: US 2009/0035109 A1
(43) Pub. Date: Feb. 5, 2009

(54) SYSTEMS AND METHODS FOR ATTACHING A VESSEL TO A TRAILER

(76) Inventor: Ronnie J. Smith, Kirkland, WA (US)

Correspondence Address: BLACK LOWE & GRAHAM, PLLC, 701 FIFTH AVENUE, SUITE 4800, SEATTLE, WA, 98104, US

(21) Appl. No.: 11/833,531

(22) Filed: Aug. 3, 2007

(51) Int. Cl. B60P 1/00; B63B 17/00

(52) U.S. Cl. 414/482; 114/343; 29/428; 414/812

(57) ABSTRACT

Systems and methods for attaching a vessel to a trailer. A system for attaching a vessel to a trailer having a winch tower includes an attachment device coupled to the vessel. A release mechanism configured to suspend the attachment device in a stand-by position. When activated, operable to release the attachment device, such that it engages the winch tower on the trailer, the result is the attachment device being in the engaged position.

### BACKGROUND OF THE INVENTION

Boating is a popular industry in the United States. People own many different types of boats from pleasure craft to fishing vessels, and sail boats to large yachts. Only a small number of those people choose to keep the vessel moored on the water. Those people who choose to launch their vessel often times deal with long lines and lots of traffic. During the boating season a wait of three hours or more is normal.

Currently in order to remove your vessel from the water, there are a number of steps a person must take in order to be successful. First the vessel is brought to a launch ramp and at least one individual disembarks from the vessel to retrieve a trailer. The vessel, after dropping its passenger, must be taken clear of the vessel launch ramp to allow others to drop off passengers. The vessel must stay offshore until the trailer is ready and submerged. Once the trailer is strategically placed in the water the vessel is guided near the trailer and at least two people attempt to attach the vessel on the trailer. These people usually get wet and must use excessive strength to ensure the vessel is correctly attached to the trailer. At the end of this process the fastest and most experienced people complete the process in ten minutes, where others take twice that time or more. This adds to the delay and creates a boat launch backup making boating less pleasurable.

### SUMMARY OF THE INVENTION

Systems and methods for attaching a vessel to a trailer are disclosed herein. A system for attaching a vessel to a trailer having a winch tower includes an attachment device coupled to the vessel. A release mechanism configured to suspend the attachment device in a stand-by position. When activated, operable to release the attachment device, such that it engages the winch tower on the trailer, the result is the attachment device being in the engaged position.

A method for installing a trailer attachment device on a vessel including securely coupling a vessel eye on a bow of the vessel. Attaching a removable attachment device to the vessel eye. Installing a release mechanism accessible from the vessel and detachably attached to the attachment device.

A method for using a trailer attachment device on a vessel including activating a vessel attachment device such that the vessel is attached to the trailer and therefore removing the vessel from the water.

### BRIEF DESCRIPTION OF THE DRAWINGS

The preferred and alternative embodiments of the present invention are described in detail below with reference to the following drawings.

FIG. 1 shows a front view of an attachment device;

FIG. 2 shows a side view of the attachment device;

FIG. 3 shows a pictorial view of a vessel on a trailer;

FIG. 4 shows a vessel with a mounted attachment device in the stand-by position;

FIG. 5 shows the attachment device in the engaged position;

FIG. 6 shows the attachment device in the stand-by position;

FIG. 7 shows the attachment device in the engaged position;

FIG. 8 shows a front view of the attachment device in the engaged position;

FIG. 9 shows a front view of the attachment device in a stand-by position;

FIG. 10 shows a method of installing a attachment device; and

FIG. 11 shows a method of using an attachment device.

### DETAILED DESCRIPTION OF THE PREFERRED EMBODIMENT

Systems and methods for retrieving a vessel from the water are disclosed herein. In typical operation, a trailer is backed into the water so that approximately two-thirds of the rollers or bunks are submerged in the water. The parking brake of the towing vehicle is set and the vehicle placed in park (or first gear if a manual transmission). The vessel is driven onto the trailer far enough so that the winch line can be attached to the bow eye of the vessel. The process is finished by pulling the vessel onto the trailer with a winch. Once the vessel is secured, the vehicle is used to pull the trailer out of the water and off of the ramp.

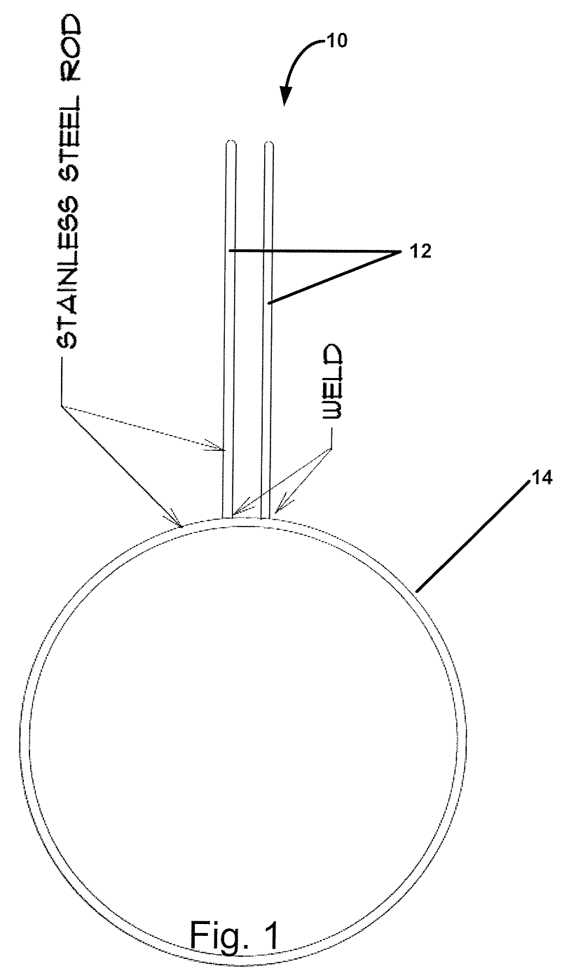

FIG. 1 shows a front view of an attachment device 10. In one embodiment the attachment device 10 is preferably constructed out of stainless steel but may also be constructed from any other suitable material. The stainless steel is constructed into two rods 14 and a first loop 12. In one exemplary embodiment the rods 14 preferably are at least 7/16 inches thick for use with a three thousand pound vessel. It is envisioned that the stainless steel may be thicker for use with heavier vessels and may be thinner for lighter boats and other personal watercraft. The first loop 12 having a circumference and a diameter. The rods 14 are attached to the first loop 12 at a first end by a weld. The rods 14 are generally the same length and aligned such that they are parallel in relation to each other. At the second end the rods 14 are looped, forming a second loop 28, and are capable of surrounding a clevis pin 26, screw or other attachment device 10. The second loop 28 at the second end preferably forms a ¾ inch eye capable of surrounding a ⅝ inch clevis pin.

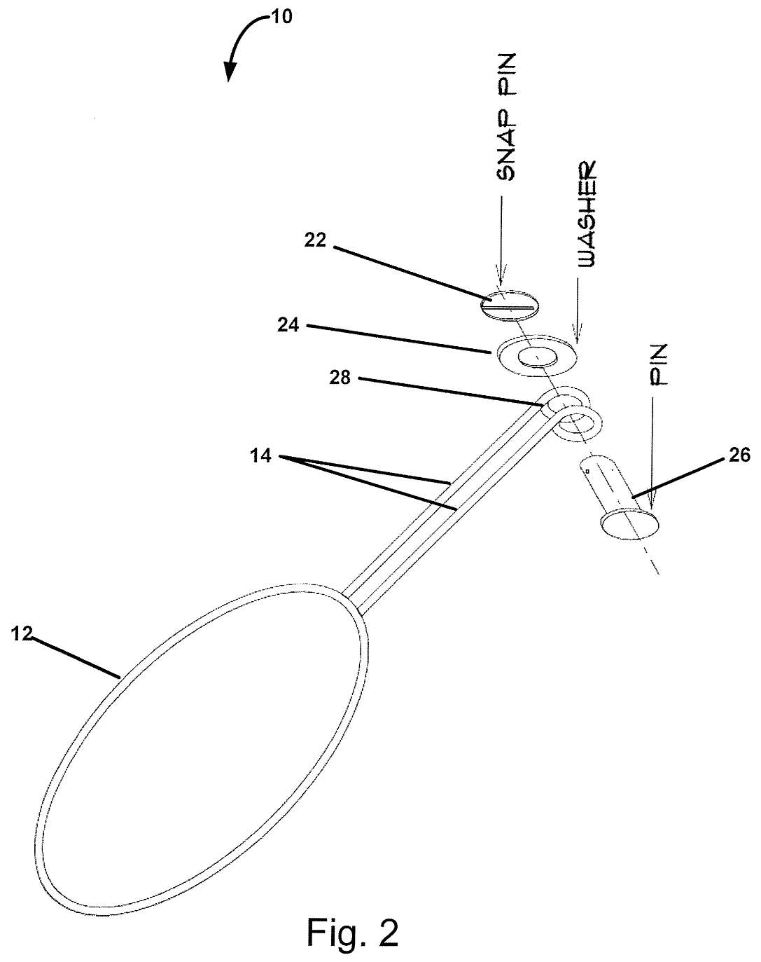

FIG. 2 shows a side view of the attachment device 10. As shown above in FIG. 1 the rods 14 are parallel and are preferably welded to the loop 12. Also shown is the second looped feature 28 at the second end of the rods 14. The rods 14 are configured to hold a clevis pin 26 that is inserted through both rods 14 at the second loop 28 in the second end. The pin 26 has an end with a hole through the body of the pin. That hole is configured to hold a snap pin 22. The pin 26 also is configured to accept a washer 24 with an inner circumference equal to the circumference of the pin 26. The pin 26 is secured by the snap pin 22 which allows for the attachment device 10 to be secured to a vessel.

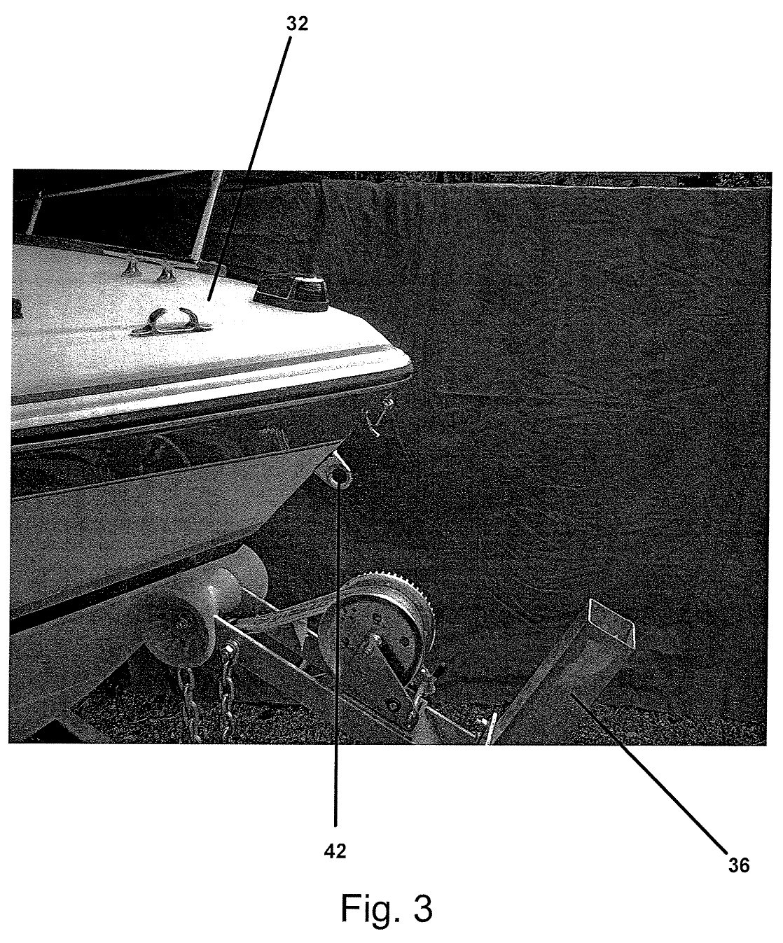

FIG. 3 shows a pictorial view of a vessel 32 on a trailer. The vessel 32 shown is a boat, but it is envisioned that it can be any type of water craft. The vessel 32 is mounted on a trailer having a winch tower 36, and a winch unit. The trailer as shown is generally known in the art. The vessel has a bow with a typical configuration known in the art. On the bow of the vessel a vessel eye 42 is installed. The vessel eye 42 is installed by drilling a hole configured to accept a vessel eye 42 and securing the vessel eye 42 with the appropriate nut and washers to secure the vessel eye 42. The installation is properly water proofed for use in the water and the vessel eye is of adequate size and weight for the intended vessel.

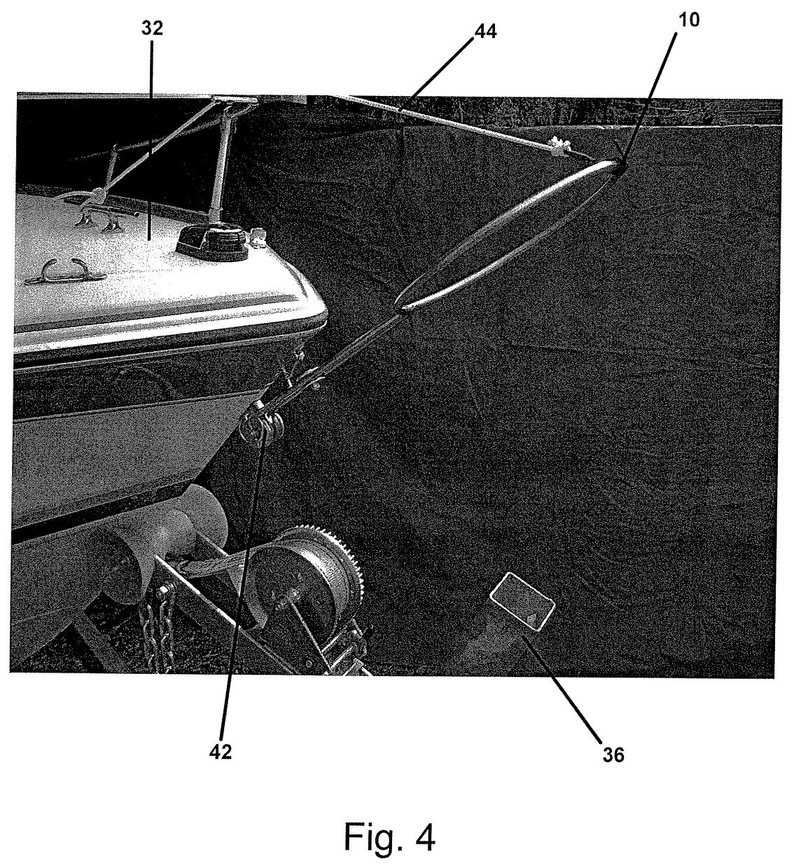

FIG. 4 shows a vessel with a mounted attachment device 10 in the stand-by position. The vessel 32 has a vessel eye 42 and a winch tower 36. The attachment device 10 is mounted on the vessel eye 42, using the clevis pin 26, washer 24 and snap pin 22 to secure the attachment device 10. In one embodiment the attachment device 10 is held in the up position by an exposed rope or cable 44. The cable 44 is secured on the vessel 32 or held taught by the operator until the vessel 32 having the attachment device 10 is aligned with the winch tower 36. The cable 44 is then released such that the attachment device 10 falls and engages the winch tower 36. In an alternate embodiment the attachment device 10 could engage any protruding part of the trailer strong enough to support the weight and or pressures of pulling the vessel out of the water without failing.

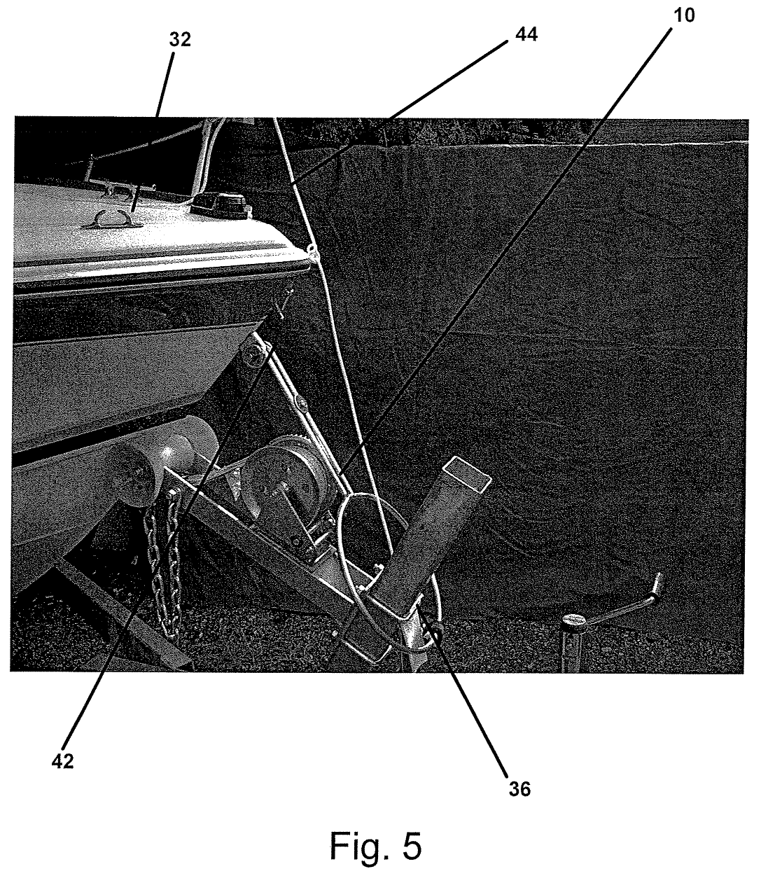

FIG. 5 shows the attachment device 10 in the engaged position. The cable 44 as shown is released and the attachment device 10 has engaged the winch tower 36. When in the engaged position, as shown, the vessel 32 will stay on a trailer and allow for movement out of the water.

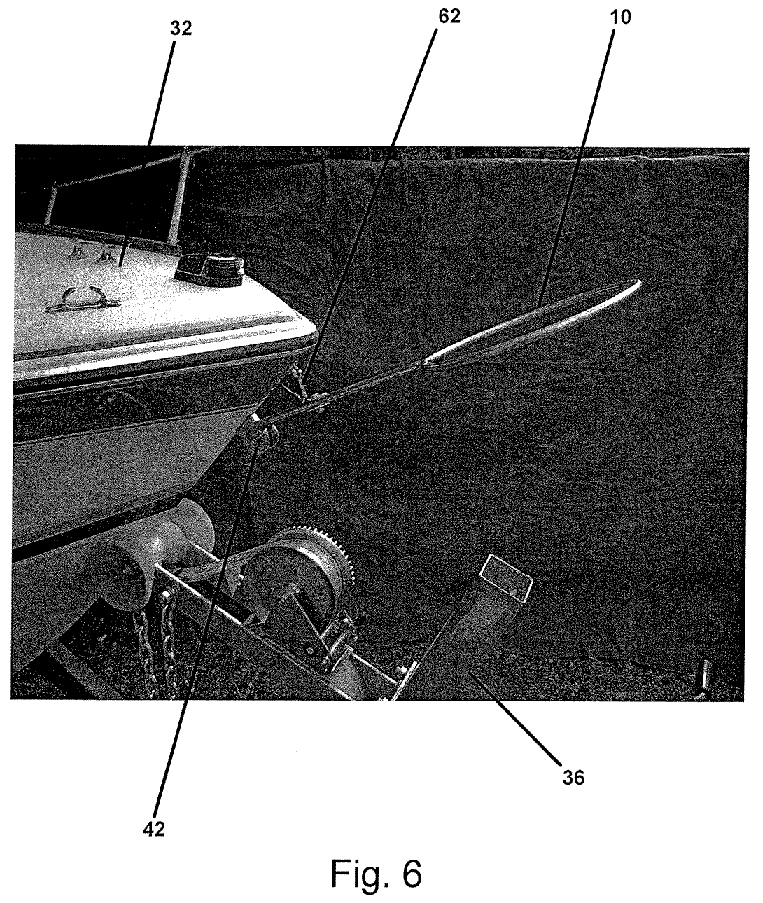

FIG. 6 shows the attachment device 10 in the stand-by position. The attachment device 10 is being suspended by a release mechanism, preferably a small hook 62, installed above the vessel eye 42 and operated by a hidden pull cable or a solenoid device (not shown). A push-button switch wired to a power supply and wiring run to the solenoid located in a forward area appropriate to operate the pull cable. The small hook 62 allows for the release of the attachment device 10 from the stand-by position to the engaged position. The hook 62 can be released automatically when the vessel 32 touches a portion of the trailer or can be operated manually by an operator.

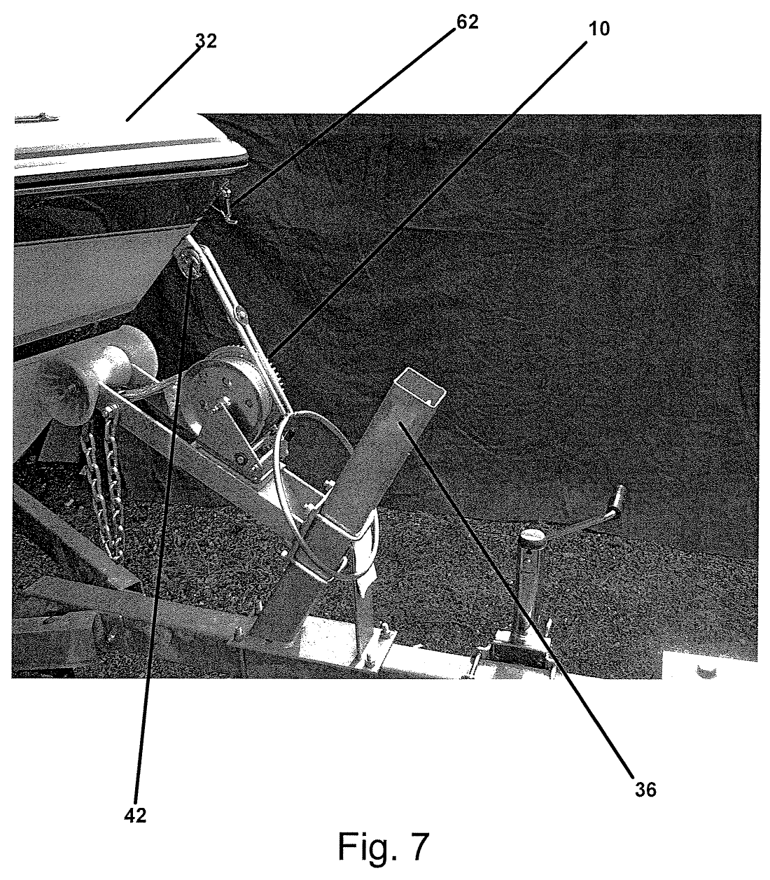

FIG. 7 shows the attachment device 10 in the engaged position. As shown the attachment device 10 has engaged the winch tower 36 or any other protruding structure from the trailer strong enough to support the weight and or pressures of pulling the vessel out of the water without failing. As shown the hook 62 stays secured to the bow of the vessel.

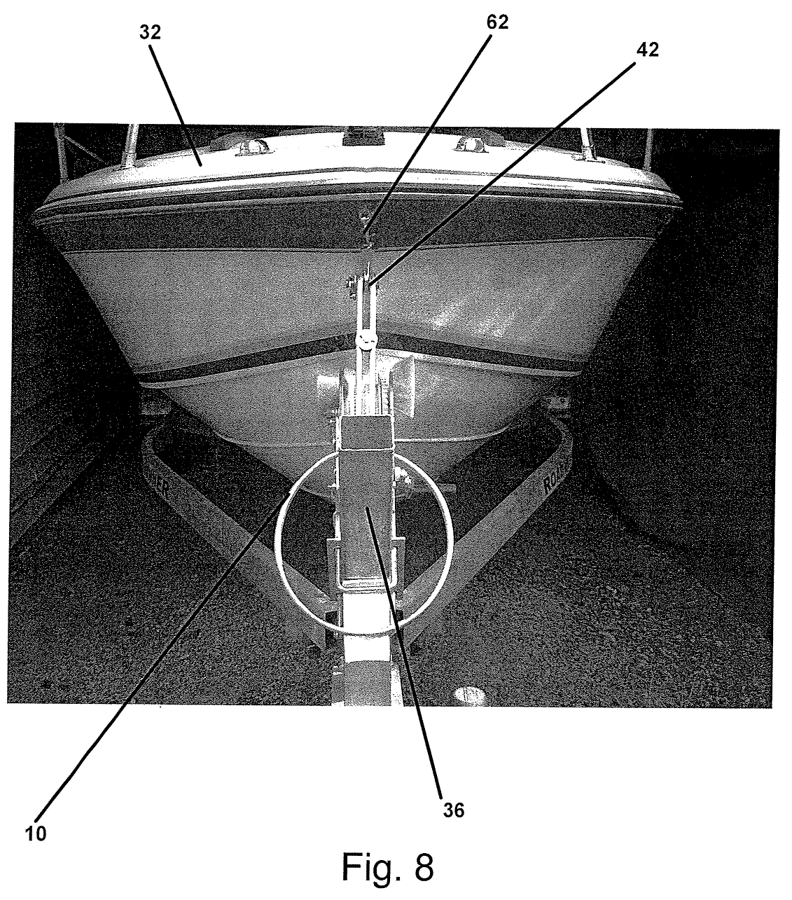

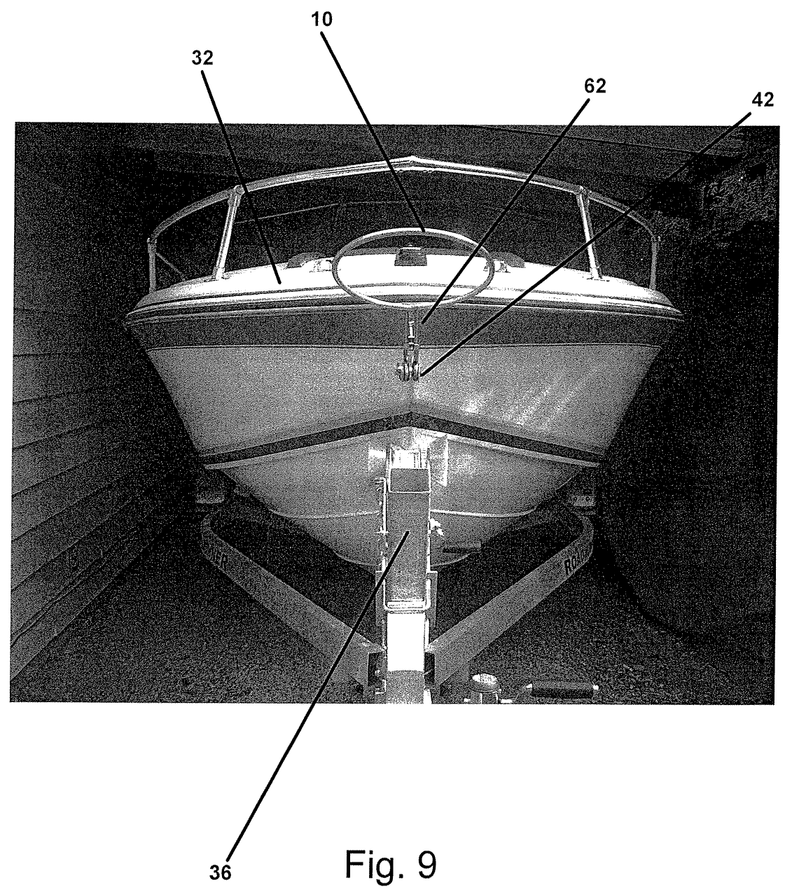

FIG. 8 shows a front view of the attachment device 10 in the engaged position. FIG. 9 shows a front view of the attachment device 10 in a stand-by position.

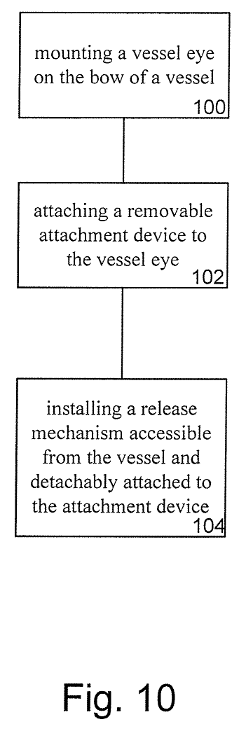

FIG. 10 shows a method of installing an attachment device 10. At block 100 a vessel eye 42 is mounted on the bow of the vessel 32. The vessel eye 42 is attached to the bow of the vessel 32 by drilling a hole and inserting the vessel eye bolt through the hole and secured with the appropriate nut and washer 24 combinations. At block 102 an attachment device 10 is attached to the vessel 32. The attachment device 10 is attached with a clevis pin 26, a washer 24 and a wire lock pin 22. The clevis pin 26 is inserted through a second loop 28 of a first rod 14, through the vessel eye 42, and finally through a second loop of a second rod. The washer 24 is installed and the wire lock pin 22 is inserted through the hole of the clevis pin 26. The attachment device 10 is locked into place. At block 104 a release mechanism is installed that is accessible from the vessel 32 and detachably attached to the attachment device 10. The release mechanism is installed above the vessel eye 42 and operated by a hidden pull cable or a solenoid device. A push-button switch wired to a power supply and wiring run to the solenoid located in a forward area appropriate to operate the pull cable. The small hook 62 allows for the release of the attachment device 10 from the stand-by position to the engaged position.

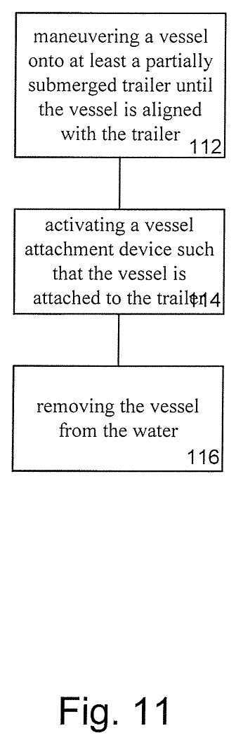

FIG. 11 shows a method of using an attachment device 10. At block 112 a vessel 32 is maneuvered onto an at least partially submerged trailer until the vessel 32 is sufficiently aligned with the trailer. The alignment of the vessel 32 to the trailer occurs when the vessel 32 is in contact with the winch tower 36 and the mid section of the vessel 32 running from bow to stern generally centered over the mid line between the front and the back of the vessel 32. The vessel attachment device 10 is preferably suspended by a release mechanism that is controlled by an operator of the vessel 32. At block 114 the vessel attachment device 10 is such that the attachment device 10 is engaged with the winch tower 36. At block 116 the vessel 32 is removed from the water by a vehicle. The vessel is removed far enough out of the water for a user to attach safety devices without entering the water.

In an alternate embodiment the attachment device 10 as shown in FIGS. 1-2 can be used as a launching device. The attachment device 10 is attached to the vessel and engaged with a winch tower as described above. Then once the vessel is floating, the attachment device 10 is lifted and the vessel is released from the trailer. The trailer is moved from the water by the vehicle.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for installing a trailer attachment device on a vessel comprising:
securely coupling a vessel eye on a bow of the vessel;
attaching a removable attachment device to the vessel eye; and
installing a release mechanism accessible from the vessel and detachably attached to the attachment device.

2. The method of claim 1 wherein coupling the vessel eye further comprises:
drilling a hole in the bow of the vessel;
inserting the vessel eye into the drilled hole; and
securing the vessel eye with a predefined washer and nut combination.

3. The method of claim 1 wherein attaching a attachment device further comprises:
inserting a pin through an eye in the attachment device and the vessel eye; and
securing the pin with a pin locking mechanism.

4. The method of claim 1 wherein installing a release mechanism further comprises:
drilling a water sealed passage for a wire;
coupling a push-button switch to the vessel and to the wire; and
coupling the wire to the release mechanism.

5. A method for using a trailer attachment device on a vessel comprising:
activating a vessel attachment device such that the vessel is attached to the trailer; and
removing the vessel from the water.

6. The method of claim 5 further comprises:
maneuvering a vessel onto at least a partially submerged trailer until the vessel is aligned with the trailer.

7. The method of claim 6 further comprising coupling the attachment device to a vessel eye coupled to the bow of the vessel.

8. The method of claim 7 wherein the attachment device further comprises a loop; and at least one rod having a first end and a second end, wherein the first end is coupled to the loop and a second end forming an eye capable of surrounding a bolt.

9. The method of claim 8, wherein the attachment device is coupled to the vessel with a bolt inserted through the vessel eye and the eye on the second end of the rod.

10. A system for attaching a vessel to a trailer having a winch tower comprising:
a attachment device coupled to the vessel; and
a release mechanism configured to suspend the attachment device in a stand-by position and when activated operable to release the attachment device such that it engages the winch tower on the trailer resulting in the attachment device being in the engaged position.

11. The system of claim 10, further comprising:
a vessel eye coupled to the bow of the vessel.

12. The system of claim 11, wherein the attachment device further comprises:
a loop; and
at least one rod having a first end and a second end, wherein the first end is coupled to the loop and a second end forming an eye capable of surrounding a bolt.

13. The system of claim 12, wherein the attachment device is coupled to the vessel with a bolt inserted through the vessel eye and the eye on the second end of the rod.

14. The system of claim 13, wherein the bolt is a clevis pin.

15. The system of claim 14 wherein the clevis pin defines a hollow end configured to accept a wire lock pin.

16. The system of claim 15 wherein the clevis pin is secured in place by at least one washer and the wire lock pin.

17. The system of claim 16 wherein the release mechanism is automatically activated.

18. The system of claim 17, wherein the release mechanism is manually activated.

19. The system of claim 18 wherein the attachment device is a hook.

20. The system of claim 19 wherein the attachment device is manufactured from stainless steel.
